(19) United States
(12) Patent Application Publication
(10) Pub. No.: US 2015/0298154 A1
(43) Pub. Date: Oct. 22, 2015

(54) Nozzle Assembly

(71) Applicants: Stuart Morgan, Moorabbin (AU); Sean Morgan, Moorabbin (AU)

(72) Inventors: Stuart Morgan, Moorabbin (AU); Sean Morgan, Moorabbin (AU)

(21) Appl. No.: 14/254,900

(22) Filed: Apr. 17, 2014

(51) Int. Cl. B05B 15/00; B05B 1/00

(52) U.S. Cl. CPC B05B 15/001; B05B 1/005

(57) ABSTRACT

A nozzle assembly 10 for delivering compressed air to a target area 36, comprising: a nozzle 30 for discharging a fluid, the nozzle 30 supported by a hand-held lance 50 at a first end 23 thereof; an end cap 40 at a second end 22 being an opposing end 22 to the first end 23; and a shield 20 attachable to said first end 23 of the nozzle assembly 10, the shield 20 protecting the nozzle 30 from damage and having a larger diameter at the first end 23 than the opposing end 22, whereby air drawn into the shield 20 and flowing passed the nozzle 30 is accelerated by the Venturi effect to deliver the compressed air to the target area 36.

### CROSS-REFERENCE TO RELATED PATENT APPLICATION

This is a continuation-in-part of application Ser. No. 12/989,047 (Pub. No. US 2011/0049274 A1) being a National Phase application of PCT Application No. PCT/AU2009/000490 (Pub. No. WO2009/129562) entered in the US on Oct. 21, 2010, the entire disclosures of each of which of the above publications shall be deemed to be incorporated by reference herein.

### TECHNICAL AREA

This invention relates to the area of nozzles and nozzle assemblies for directing compressed air to a target area. In particular, this invention relates to an apparatus for use with a nozzle which helps protect the nozzle from damage.

### BACKGROUND TO THE INVENTION

Typically hand held air blowing lances are used in many industries, one particularly prominent area being the paper industry. These lances have a special air nozzle at one end designed to efficiently direct compressed air in an air jet of a concentrated pattern with a maximised distance of throw and maximised force to carry out whatever task is required including blowing or directing sheet paper onto the rolls of a paper mill, clearing out paper remnants from a machine where a breakage has occurred or blowing away waste from a production application.

These nozzles are typically quite costly and include safety shut off devices and triggers which are vulnerable to damage which may arise from accidental dropping of the lance on the ground or bumping it upon other objects. Thus typically the nozzles are damaged severely with everyday use to the extent that they must be replaced more regularly than would be required were it not for accidental damage.

It is an object of the invention to ameliorate the above problems by providing an effective protective shield or bumper for a nozzle forming part of a nozzle assembly. It is a further object of the invention that the protective shield does not hinder the resultant air flow, but preferably enhances the air flow.

### OUTLINE OF THE INVENTION

In one aspect, the invention is a shield which is attachable to a nozzle assembly for delivering compressed air to a target area, the nozzle assembly having a nozzle supported by a hand held lance, such that the nozzle is protected from damage while air flow through the nozzle is not substantially impeded.

In another aspect, the invention provides a nozzle assembly for delivering compressed air to a target area, comprising:
a nozzle for discharging a fluid, the nozzle supported by a hand-held lance at a first end thereof;
an end cap at a second end being an opposing end to the first end; and
a shield attachable to said first end of the nozzle assembly, the shield protecting the nozzle from damage and having a larger diameter at the first end than the opposing end,
whereby air drawn into the shield and flowing passed the nozzle is accelerated by the Venturi effect to deliver the compressed air to the target area.

The nozzle assembly preferably delivers a flow of compressed air that is not pulsed but is of consistent flow, preferably controlled by a trigger or handle lever, as is common for compressed air handgun actuators in the art. The nozzle assembly preferably delivers compressed air of the order of about of the order of about 150 to about 1500 KPa (1.5-15 Bar or about 14 to about 200 PSI), and still more preferably about 200 to about 1000 KPa (2-10 Bar or about 30 to about 150 PSI) to a target area. Still more preferably, the nozzle assembly delivers compressed air of the order of about 250 to about 450 KPa (2.5-4.5 Bar or about 35 to about 65 PSI) to a target area.

The target area may include the rolls of a paper mill wherein compressed air is used to blow or direct sheet paper onto the rolls of a paper mill, a machine where a breakage has occurred wherein compressed air is directed to the site for clearing out paper remnants from the machine or waste where waste is to be blown away from a production application. The target area comprises industrial applications and not human targets. Care should be taken to avoid directing the nozzle toward the eyes and exposed skin, particularly at higher pressures.

It is preferred that the shield be coupled to the air nozzle assembly at a position between the nozzle tip and the hand held lance. It is further preferred that this position be between the nozzle end cap and an end of the handle which would otherwise connect to the end cap.

It is preferred that the shield be generally frusto-conical in shape with a first narrower end extending forward of the nozzle aperture. It is also preferred that a second end of the shield have a wider diameter than the first end and be spaced from the handle by means of a plurality of lugs. It is further preferred that four equally spaced lugs be used such that air can flow into the shield at this second end and accelerate out the first end.

In order that the invention may be more readily understood we will describe by way of non limiting example one specific embodiment of the invention as detailed in the following drawings.

### BRIEF DESCRIPTION OF THE DRAWING FIGURES

FIG. 1 is a cross-sectional view of a shielded hand held air blowing lance according to the preferred embodiment of the invention; and

FIG. 2 is an exploded view of the shield, nozzle and lance components according to the preferred embodiment of the invention.

### DESCRIPTION OF AN EMBODIMENT OF THE INVENTION

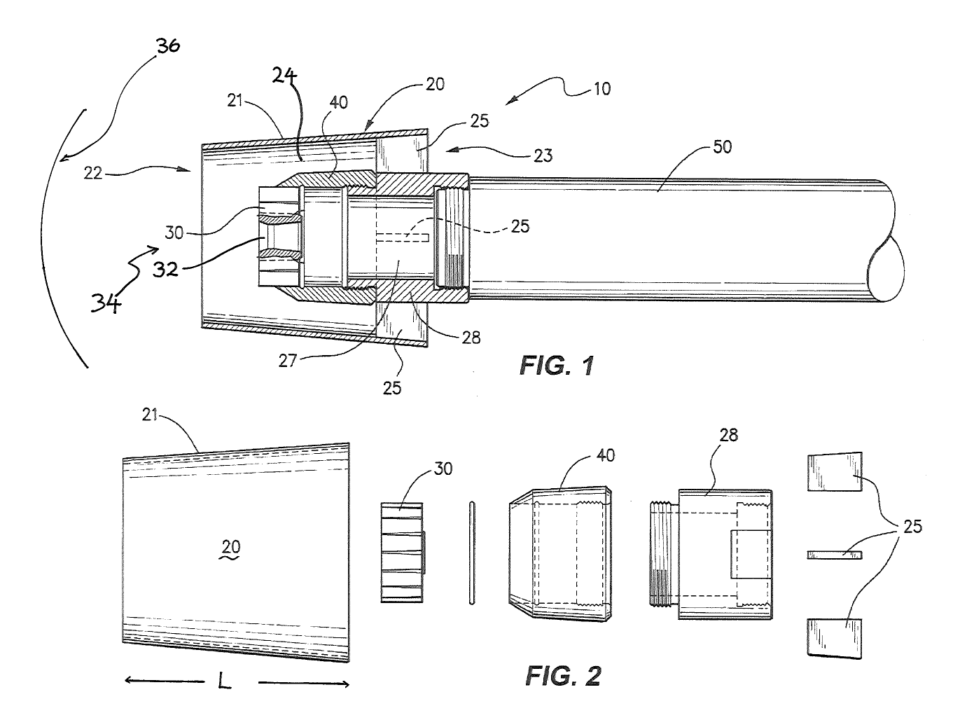

Referring to FIGS. 1 and 2, there is shown a hand held air blowing lance 10 for a spray nozzle 30. In the absence of a shield 20, the air nozzle 30 would be located in an end cap 40 which would connect directly to a handle 50 of an air blowing lance. However, in the present embodiment, the hand held air blowing lance 10 has a protective shield 20 attached at a first lance end 23 of the nozzle 30. The shield 20 protects the nozzle at a nozzle end 22 of the nozzle 30. The shield 20 not only preforms as a shield, but also is operable to direct air flow in the region of the nozzle 30 so as not to disrupt the desired flow pattern. In fact, the tapered conical shape of the shield 20 concentrates air drawn into the entrance to the shield at the first end 23 when the nozzle is operating to dispense fluid through its orifice 32, air in significant volume is drawn into the vicinity of the nozzle orifice 32 in the region 34 to provide a high volume stream of compressed air from a narrow concentrated stream of original nozzle fluid generated from the nozzle orifice 32.

The nozzle assembly 10 stream of fluid emanating from the nozzle orifice 32 is controlled in the normal manner by a hand or finger-operated lever or trigger controlled by an operator hold the hand-held lance 50. Whilst the nozzle assembly 10 is actuated, the stream of fluid generated from the nozzle orifice 32 and hence the stream of targeted compressed air generated by the nozzle assembly 10 is continuous and constant.

The shield 20 is preferably frusto-conical in shape with a solid outer wall 21 defining a hollow interior 24. This exterior surface 21 is correspondingly frusto-conical in shape. Air enters the hollow interior 24 at the first end 23 where it has a larger diameter than the second end 22 through which the air exits the shield 20. Coupled with the high velocity flow of fluid generated through the orifice 32, the air drawn through the shield opening at the first end 23 is accelerated as it travels through the shield 20. The speed, relative to passive air, and volume, relative to fluid from the orifice 32, of air flow in the vicinity 34 of the nozzle orifice 32, is enhanced by the shield 20, rather than causing any diminution of the flow. The exact shape of the shield is not restricted in the invention save that the frusto-conical shape described above is preferred due to its contribution to the flow.

The hollow interior 24 is defined by the exterior wall 24 to be a substantially continuous annular chamber surrounding the nozzle 30. The shield 20 could be described as a skirt extending from a location substantially upstream relative to the orifice 32 to substantially downstream beyond the mouth of the orifice 32. The shield 20 has an axial length L. The shield 20 overhangs the nozzle 30 at its orifice 32 by about one quarter of the shield's length L. Accordingly air flow travels about half to three quarters of the length L of the shield 20 before mixing with fluid that emanates from the orifice 32.

The shield 20 has adjacent its base 28 at least two spacers or lugs 25 extending between the base support component 28 and the exterior 21. It is preferred that there be four such spacers or lugs 25 at equal intervals about the handle to permit air to readily flow into the shield 20 at its first end 23 and out its opposing end 22. However, the skilled person sill appreciate that the number of lugs or spacers 25 could be varied as long as the shield is held radially firmly relative to the base 28 to withstand the shocks and buffeting which the shield 20 is required withstand to protect the nozzle 30, whilst not impeding the flow of air into the chamber 24.

The number of spacers or lugs 25 used to hold the shield exterior 21 out from the nozzle assembly 10 in any way restricted in the invention although the number preferred here is designed to provide minimal impediment to air flow which still providing sufficient strength to affect the purpose of the shield 20.

The support component 28 of the nozzle 30 to which the spacers 25 are connected is a circular member adapted to engage between the nozzle end cap 40 and the handle 50. It has a central aperture 27 which is concentric with that of the handle 50 and end cap 40. While in this embodiment of the invention this support component 28 is situated adjacent the opening of the shield at the first end 23, the invention is not restricted in this regard, the shield 20 able to be positioned, for example, by being mounted on the end cap rather than on the base 28.

The shield 20 of the invention acts to protect the nozzle 30 from accidental damage and has the added advantage that its shape helps to create a Venturi effect which accelerates air flow through it, when the air blowing lance is in use, and hence enhances the air blowing effect of the lance rather than in any way impeding the air flow from the lance by its presence.

The nozzle assembly 10 is typically adapted for use in the paper mill industry or other industrial settings and, accordingly, should be made using robust materials, mouldings, castings and connections. The shield 20 is preferably formed from high grade steel, cast or machined, with high quality welds to ensure the connections between the lugs 25, shield 20 and base 28 are strong and able to withstand the normal shocks and buffeting one would expect in an industrial setting.

The lance handle 50 is preferably a rigid or semi-rigid rod providing a conduit for fluid flow, as well as forming a suitable section for handling. if the fluid delivered is other than room temperature, insulation may need to be provided. The handle 50 typically comprises a fluid delivery control hand lever (not shown) that controls a valve (not shown) in the lance 50 that interrupts the flow of fluid to the nozzle orifice 32. By operation of the hand lever, the operator can control the delivery of compressed air to the target area from the nozzle assembly 10.

1. A nozzle assembly for delivering compressed air to a target area, comprising:
a nozzle for discharging a fluid, the nozzle supported by a hand-held lance at a first end thereof;
an end cap at a second end being an opposing end to the first end; and
a shield attachable to said first end of the nozzle assembly, the shield protecting the nozzle from damage and having a larger diameter at the first end than the opposing end,
whereby air drawn into the shield and flowing passed the nozzle is accelerated by the Venturi effect to deliver the compressed air to the target area.

2. The nozzle assembly according to claim 1, wherein said continuous flow of compressed air is manually controlled by a hand-operated actuator.

3. The nozzle assembly according to claim 1, wherein at least half of the length of said shield extends upstream relative said end cap and the remaining portion of said shield overhangs downstream of said nozzle end cap.

4. The nozzle assembly according to claim 1, wherein said shield overhangs said end cap at the downstream end by about a quarter of its length.

5. The nozzle assembly according to claim 1, wherein said shield is a substantially annular device extending laterally from said nozzle and supported by lugs extending therefrom.

6. The nozzle assembly according to claim 1, wherein said shield has a substantially frusto-conical shape with the narrower opposing end extending forward of an aperture of said nozzle.

7. The nozzle assembly according to claim 6, wherein said first end is spaced from said nozzle via a plurality of lugs.

8. The nozzle assembly according to claim 7, wherein said plurality of lugs is four substantially equally-spaced lugs that provide minimal impediment to air flow through the shield.

9. The nozzle assembly according to claim 1, wherein said shield includes a plurality of spacers and a support component which is connected to said spacers, said support component being a circular member adapted to engage between said end cap and a handle of said hand-held lance and having a central aperture which is concentric with that of said handle and said end cap.

10. The nozzle assembly according to claim 2, wherein the compressed air is delivered as a continuous flow to a target area.

11. The nozzle assembly according to claim 10, wherein the target area involves a paper mill application.
